(19) United States
(12) Patent Application Publication
(10) Pub. No.: US 2022/0026537 A1
(43) Pub. Date: Jan. 27, 2022

(54) SYSTEMS AND METHODS FOR SENSING ROTATION ANGLES OF A MICRO MIRROR IN AN OPTICAL SENSING SYSTEM

(71) Applicant: BEIJING VOYAGER TECHNOLOGY CO., LTD., Beijing (CN)

(72) Inventors: Youmin Wang, Mountain View, CA (US); Yufeng Wang, Mountain View, CA (US); Gary Li, Mountain View, CA (US)

(73) Assignee: BEIJING VOYAGER TECHNOLOGY CO., LTD., Beijing (CN)

(21) Appl. No.: 16/936,318

(22) Filed: Jul. 22, 2020

(51) Int. Cl. G01S 7/481; G01B 7/30; G01D 5/14; G01S 17/931; G01S 17/10

(52) U.S. Cl. CPC G01S 7/4817; G01B 7/30; G01S 17/10; G01S 17/931; G01D 5/14

(57) ABSTRACT

Embodiments of the disclosure provide systems and methods for reflecting optical signals in an optical sensing system. The micromachined mirror assembly includes a micro mirror and at least one actuator mechanically connected to the micro mirror through at least one connection, configured to drive the micro mirror to tilt for a rotation angle around an axis, causing an in-plane stress on the at least one connection. The micromachined mirror assembly also includes at least one piezoelectric sensor configured to detect the rotation angle of the micro mirror based on a signal indicative of the in-plane stress sensed at the at least one connection.

### TECHNICAL FIELD

The present disclosure relates to optical sensing systems such as a light detection and ranging (LiDAR) system, and more particularly to, systems and methods for sensing rotation angles of a micro mirror in an optical sensing system using a piezoelectric sensor.

### BACKGROUND

Optical sensing systems such as LiDAR systems have been widely used in advanced navigation technologies, such as to aid autonomous driving or to generate high-definition maps. For example, a typical LiDAR system measures the distance to a target by illuminating the target with pulsed laser light beams and measuring the reflected pulses with a sensor such as a photodetector or a photodetector array. Differences in laser light return times, wavelengths, and/or phases can then be used to construct digital three-dimensional (3D) representations of the target. Because using a narrow laser beam as the incident light can map physical features with very high resolution, a LiDAR system is particularly suitable for applications such as sensing in autonomous driving and high-definition map surveys.

The pulsed laser light beams emitted by a LiDAR system are typically directed to multiple directions to cover a field of view (FOV). Various methods can be used to control the directions of the pulsed laser light beams. To precisely steer the direction of the light beam, the rotation angle of the micro mirror must be precisely controlled. A close loop control, where the mirror assembly is controlled based on a measurement of the current rotation angle is widely used. This requires an accurate measurement of current mirror rotation angle at each time point while scanning.

Conventional rotation angle measurements, such as using capacitive sensor, piezoresistive sensor, or position sensitive device (PSD), suffer from various problems. For example, the PSD is expensive and difficult to integrate with the micro mirror, the capacitive sensor has difficulty indicating the direction of the rotation while keeping the structure simple, and the piezoresistive sensor needs specially designed extra circuit for reading out the sensing result.

### SUMMARY

Embodiments of the disclosure provide micromachined mirror assembly for reflecting optical signals in an optical sensing system. The micromachined mirror assembly includes a micro mirror and at least one actuator mechanically connected to the micro mirror through at least one connection, configured to drive the micro mirror to tilt for a rotation angle around an axis, causing an in-plane stress on the at least one connection. The micromachined mirror assembly also includes at least one piezoelectric sensor configured to detect the rotation angle of the micro mirror based on a signal indicative of the in-plane stress sensed at the at least one connection.

Embodiments of the disclosure also provide a method for sensing rotation angles of a micro mirror. The method includes driving the micro mirror to tilt for a rotation angle around an axis using at least one actuator mechanically connected to the micro mirror through at least one connection, wherein the tilting of the micro mirror causes an in-plane stress on the at least one connection. The method also includes sensing, using a piezoelectric sensor, a signal indicative of the in-plane stress at the at least one connection. The method further includes determining the rotation angle of the micro mirror based on the sensed signal.

Embodiments of the disclosure further provide an optical sensing system. The system includes a transmitter configured to emit optical signals in a plurality of directions and a receiver configured to detect reflected optical signals. The system further includes a micromachined mirror assembly. The micromachined mirror assembly includes a micro mirror and at least one actuator mechanically connected to the micro mirror through at least one connection, configured to drive the micro mirror to tilt for a rotation angle around an axis, causing an in-plane stress on the at least one connection. The micromachined mirror assembly also includes at least one piezoelectric sensor configured to detect the rotation angle of the micro mirror based on a signal indicative of the in-plane stress sensed at the at least one connection.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR system, according to embodiments of the disclosure.

FIG. 2 illustrates a block diagram of an exemplary LiDAR system, according to embodiments of the disclosure.

FIG. 3A illustrates a schematic diagram of an exemplary micromachined mirror assembly, according to embodiments of the disclosure.

FIG. 3B illustrates a cross-section view of the micromachined mirror assembly shown in FIG. 3A.

FIG. 4 illustrates a cross-section view of an exemplary actuator, according to embodiments of the disclosure.

FIG. 5 illustrates the relationship between the polarization direction, the electrical signal and the expansion direction of an exemplary piezoelectric material working in a transversal mode, according to embodiments of the disclosure.

FIG. 6 illustrates waveforms of an exemplary set of voltage signals applied to the actuators of the micromachined mirror assembly, according to embodiments of the disclosure.

FIG. 7 illustrates a schematic diagram of exemplary connections and an exemplary micromachined mirror assembly with connection arrays, according to embodiments of the disclosure.

FIG. 8 illustrates a cross-section view of an exemplary piezoelectric sensor, according to embodiments of the disclosure.

FIG. 9 illustrates an exemplary differentiator, according to embodiments of the disclosure.

FIG. 10 illustrates a cross-section view of an exemplary piezoelectric sensor with reduced parasitic capacitance, according to embodiments of the disclosure.

FIG. 11 illustrates a flow chart of an exemplary method for sensing rotation angles of a micro mirror within a micromachined mirror assembly, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the present disclosure provide systems and methods for sensing rotation angle of micro mirror(s) in an optical sensing system (e.g., a LiDAR system) using one or more piezoelectric sensors. For example, the micro mirror can be driven by the actuator(s) such as piezoelectric actuator(s), electrostatic actuator(s), magnetic actuator(s), or any of the combination, to tilt certain angles around an axis, thereby directing (e.g., guiding, reflecting, inflecting, and/or diffracting) incident laser beams from a laser source towards certain directions to, for example, scan an FOV. The mirror can be a single micro mirror, or an array of micro mirrors integrated into a micromachined mirror assembly made from semiconductor materials using microelectromechanical system (MEMS) technologies.

To drive the mirror, the actuator is connected to the micro mirror by at least one connection. For example, the connection may be configured to convert a vertical movement of the actuator to a rotational movement (e.g., titling) of the micro mirror by connecting an edge of the mirror (e.g., one side of the mirror parallel to the titling axis) to the actuator through the connection. In some embodiments, one actuator may be connected to one side of the mirror through the connection to actuate the movement. In some other embodiments, two actuators connected to opposite sides of the mirror may cause movements with different phases to enhance the titling effect. In some embodiments, the at least one connection may include an array of connections with a gap between every two adjacent connections, such that when applying same amount of driving force, the stress applied to the micro mirror through each connection of the array is reduced.

In some embodiments, the titling of the micro mirror may cause an in-plane stress on each connection. The in-plane stress may be detected using a piezoelectric sensor based on detecting an electrical signal (e.g., a voltage) from a piezoelectric material caused by the in-plane stress due to the piezo-electric effect. The rotation angle of the micro mirror may be proportional to the signal sensed by the piezoelectric sensor, and thus can be determined through an empirical formula or a lookup table indicating a relationship between the electric signal and the rotation angle of the micro mirror. Accordingly, the rotation of the micro mirror can be accurately measured and thus, the micro mirror can be controlled more precisely to scan the FOV.

Embodiments of the present disclosure improve the performance of micro mirror and lower the cost of sensing rotation angles of a micro mirror in an optical sensing system, which can be used in many applications. For example, the optical sensing system with the improved rotation angle sensing scheme can be used in advanced navigation technologies, such as to aid autonomous driving or to generate high-definition maps, in which the optical sensing system can be equipped on a vehicle.

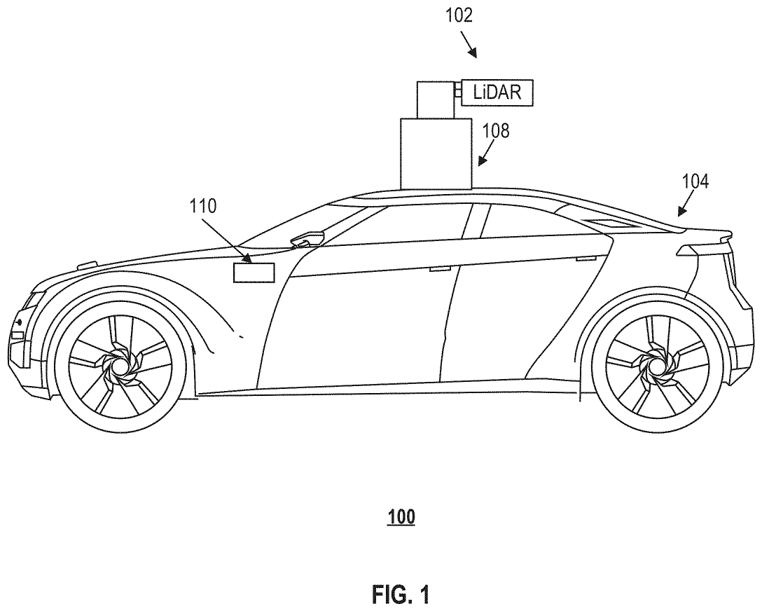

For example, FIG. 1 illustrates a schematic diagram of an exemplary vehicle 100 equipped with an optical sensing system (e.g., a LiDAR system) 102 (hereinafter also referred to as LiDAR system 102), according to embodiments of the disclosure. Consistent with some embodiments, vehicle 100 may be a survey vehicle configured for acquiring data for constructing a high-definition map or 3-D buildings and city modeling. Vehicle 100 may also be an autonomous driving vehicle.

As illustrated in FIG. 1, vehicle 100 may be equipped with LiDAR system 102 mounted to a body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. Vehicle 100 may be additionally equipped with a sensor 110 inside or outside body 104 using any suitable mounting mechanisms. Sensor 110 may include sensors used in a navigation unit, such as a Global Positioning System (GPS) receiver and one or more Inertial Measurement Unit (IMU) sensors. It is contemplated that the manners in which LiDAR system 102 or sensor 110 can be equipped on vehicle 100 are not limited by the example shown in FIG. 1 and may be modified depending on the types of LiDAR system 102 and sensor 110 and/or vehicle 100 to achieve desirable 3D sensing performance.

Consistent with some embodiments, LiDAR system 102 and sensor 110 may be configured to capture data as vehicle 100 moves along a trajectory. For example, a transmitter of LiDAR system 102 may be configured to scan the surrounding environment. LiDAR system 102 measures distance to a target by illuminating the target with pulsed laser beam and measuring the reflected pulses with a receiver. The laser beam used for LiDAR system 102 may be ultraviolet, visible, or near infrared. In some embodiments of the present disclosure, LiDAR system 102 may capture point clouds including depth information of the objects in the surrounding environment. As vehicle 100 moves along the trajectory, LiDAR system 102 may continuously capture data.

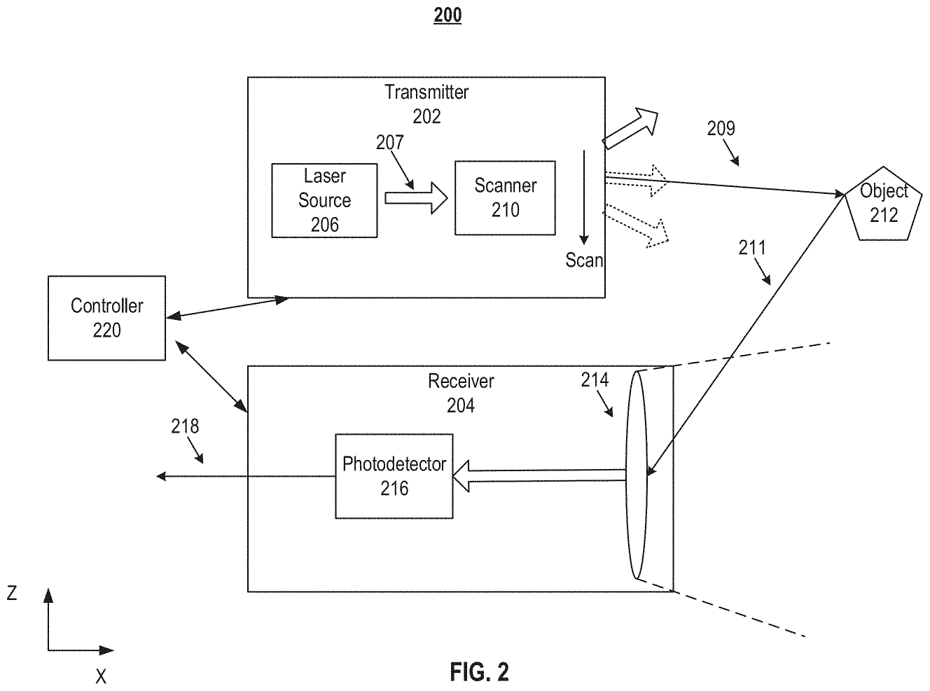

FIG. 2 illustrates a block diagram of an exemplary LiDAR system 102, according to embodiments of the disclosure. LiDAR system 102 may include a transmitter 202 and a receiver 204. Transmitter 202 may emit laser beams along multiple directions. Transmitter 202 may include one or more laser sources 206 and a scanner 210. As will be described below in greater detail, scanner 210 may include a micromachined mirror assembly having a micro mirror driven by actuator(s) such as piezoelectric actuator(s).

Transmitter 202 can sequentially emit a stream of pulsed laser beams in different directions within a scan range (e.g., a range in angular degrees), as illustrated in FIG. 2. Laser source 206 may be configured to provide a laser beam 207 (also referred to as “native laser beam”) to scanner 210. In some embodiments of the present disclosure, laser source 206 may generate a pulsed laser beam in the ultraviolet, visible, or near infrared wavelength range.

In some embodiments of the present disclosure, laser source 206 may include a pulsed laser diode (PLD), a vertical-cavity surface-emitting laser (VCSEL), a fiber laser, etc. For example, a PLD may be a semiconductor device similar to a light-emitting diode (LED) in which the laser beam is created at the diode's junction.

Scanner 210 may be configured to emit a laser beam 209 to an object 212 in a first direction. Object 212 may be made of a wide range of materials including, for example, non-metallic objects, rocks, rain, chemical compounds, aerosols, clouds and even single molecules. The wavelength of laser beam 209 may vary based on the composition of object 212. In some embodiments, at each time point during the scan, scanner 210 may emit laser beam 209 to object 212 in a direction within a range of scanning angles by rotating the micromachined mirror assembly. In some embodiments of the present disclosure, scanner 210 may also include optical components (e.g., lenses, mirrors) that can focus pulsed laser light into a narrow laser beam to increase the scan resolution and the range to scan object 212.

In some embodiments, receiver 204 may be configured to detect a returned laser beam 211 returned from object 212. The returned laser beam 211 may be in a different direction from beam 209. Receiver 204 can collect laser beams returned from object 212 and output electrical signals reflecting the intensity of the returned laser beams. Upon contact, laser light can be reflected by object 212 via backscattering, such as Rayleigh scattering, Mie scattering, Raman scattering, and fluorescence. As illustrated in FIG. 2, receiver 204 may include a lens 214 and a photodetector 216. Lens 214 may be configured to collect light from a respective direction in its field of view (FOV). At each time point during the scan, returned laser beam 211 may be collected by lens 214. Returned laser beam 211 may be returned from object 212 and have the same wavelength as laser beam 209.

Photodetector 216 may be configured to detect returned laser beam 211 returned from object 212. In some embodiments, photodetector 216 may convert the laser light (e.g., returned laser beam 211) collected by lens 214 into an electrical signal 218 (e.g., a current or a voltage signal). Electrical signal 218 may be generated when photons are absorbed in a photodiode included in photodetector 216.

LiDAR system 200 may further include one or more controllers, such as a controller 122. Controller 220 may control the operation of transmitter 202 and/or receiver 204 to perform detection/sensing operations. Controller 220 may include components (not shown) such as a communication interface, a processor, a memory, and a storage for performing various control functions. In some embodiments, controller 220 may have different modules in a single device, such as an integrated circuit (IC) chip (implemented as, for example, an application-specific integrated circuit (ASIC) or a field-programmable gate array (FPGA)), or separate devices with dedicated functions. In some embodiments, the processor may include any appropriate type of general-purpose or special-purpose microprocessor, digital signal processor, or microcontroller. The memory or storage may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. For example, the memory and/or the storage may be configured to store program(s) that may be executed by the processor to control the operation of scanner 210.

While scanner 210 is described as part of transmitter 202, it is understood that in some embodiments, scanner 210 can be part of receiver 204, e.g., before photodetector 216 in the light path. The inclusion of scanner 210 in receiver can ensure that photodetector 216 only captures light, e.g., returned laser beam 211 from desired directions, thereby reducing interferences from other light sources, such as the sun and/or other LiDAR systems.

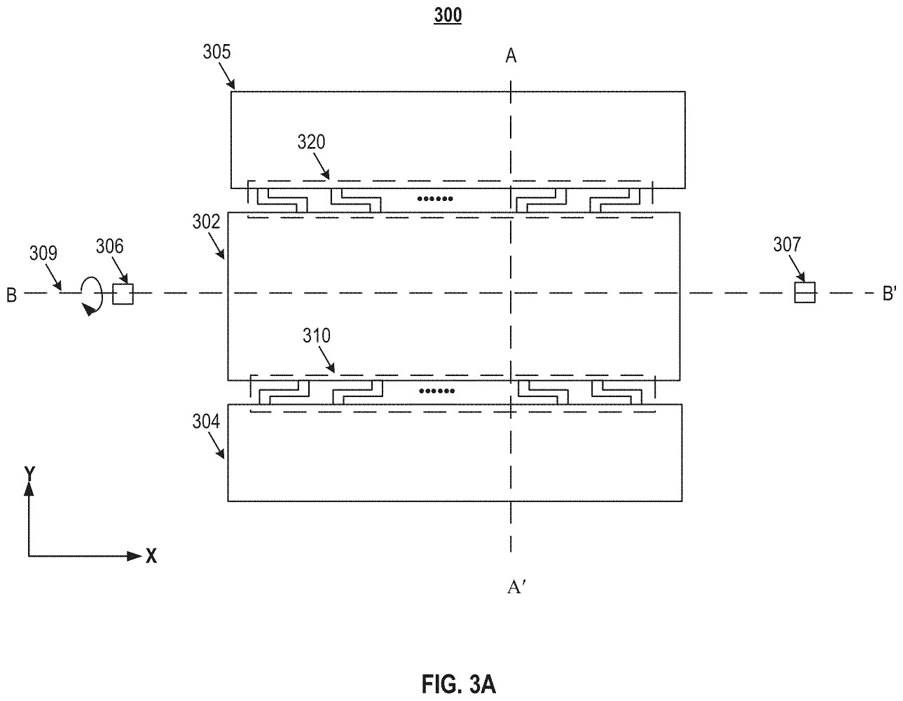

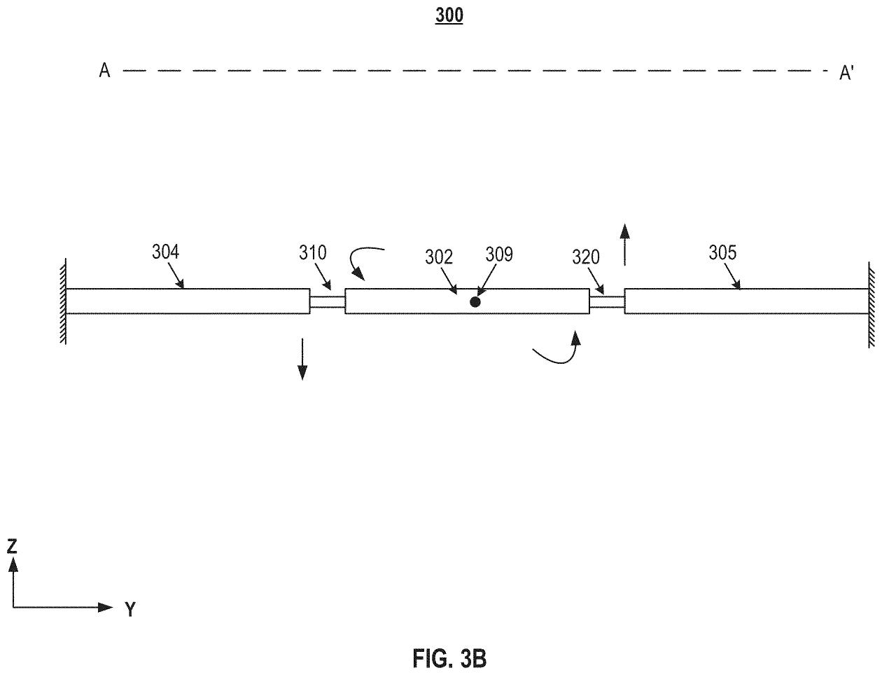

In some embodiments, the incident angle of laser beam 207 may be fixed relative to scanner 210, and the scanning of laser beam 209 may be achieved by rotating (e.g., tilting) a micro mirror or an array of micro mirror assembled in scanner 210. FIG. 3A illustrates a schematic diagram of an exemplary micromachined mirror assembly 300, according to embodiments of the disclosure. FIG. 3B illustrates a cross-section view along line A-A′ of micromachined mirror assembly 300 shown in FIG. 3A, according to embodiments of the disclosure.

Different from conventional micromachined mirror assemblies that have difficulties detecting rotation angle of the micro mirror precisely with simple structure, the micromachined mirror assembly 300 shown in FIG. 3A uses one or more piezoelectric sensors mechanically coupled to the connections (e.g., connections in connection arrays 310 and 320) connecting actuator(s) and side(s) of the micro mirror. When the micro mirror tilts around a titling axis of the micromachined mirror assembly, an in-plane stress is caused by within the connection. This in-plane stress can cause a piezoelectric material coupled to the connection to expand/contract (herein after referred as “expansion”, the opposite of which is referred to as “contraction”) in a first direction in parallel with the titling axis. The expansion of the piezoelectric material may cause an electric field in a second direction, perpendicular to the titling axis and the first direction (e.g., the piezoelectric material may be in the transversal mode (d₃₁)). The electric field caused by the expansion may be sensed/detected by piezoelectric sensor(s) and be used for determining the rotation angle of the micro mirror. For example, the detected electric signal may be proportional to the rotation angle.

As illustrated in FIGS. 3A and 3B, in some embodiments, micromachined mirror assembly 300 may include a micro mirror 302 and a pair of actuators 304 and 305. In some embodiments, micromachined mirror assembly 300 may include only one actuator or more than two actuators. A first connection array 310 is mechanically coupled to one side of micro mirror 302, and a second connection array 320 is mechanically coupled to the opposite side of micro mirror 302. Each of first connection array 310 and second connection array 320 may include a plurality of connections.

In some embodiments, micro mirror 302 may be pivotally supported (e.g., by a gimbal structure) by anchors 306 and 307, and be suspended (as shown in FIG. 3B) by first connection array 310 and second connection array 320 to allow limited movement of micro mirror 302 around a tilting axis 309 (also referred to as axis 309). Axis 309 may be defined by a connecting line between anchors 306 and 307. Anchors 306 and 307 may be fixed to a substrate (not shown) over which micro mirror 302 is suspended, for providing the pivoted support.

In some embodiments, micro mirror 302 may be covered by a reflective layer disposed on its top surface (e.g., facing incident laser beam(s)). The reflective layer may form a reflective surface to reflect an incident laser beam, thereby forming a reflected laser beam. By tilting micro mirror 302 to a different angle, the incident laser beam may be reflected to a different direction, forming another reflected laser beam. It is to be understood that although micro mirror 302 is in a rectangle shape as shown in FIG. 3A, the shape of micro mirror 302 is not limited to a rectangle shape, and may vary in other examples, such as a square, round, or eclipse shape.

In some embodiments, micromachined mirror assembly 300 may further include first and second actuators 304 and 305 (also referred as actuator 304/305), each mechanically coupled to an opposite edge of micro mirror 302 (e.g., each edge being parallel to axis 309) through first connection array 310 and second connection array 320 respectively. As illustrated in FIG. 3B each one of actuators 304 and 305 may be fixed on one end (e.g., the end that is not connected to micro mirror 302) and be movable on the other end. The movable end may be connected to micro mirror 302 and can move vertically to drive micro mirror 302 to tilt around axis 309.

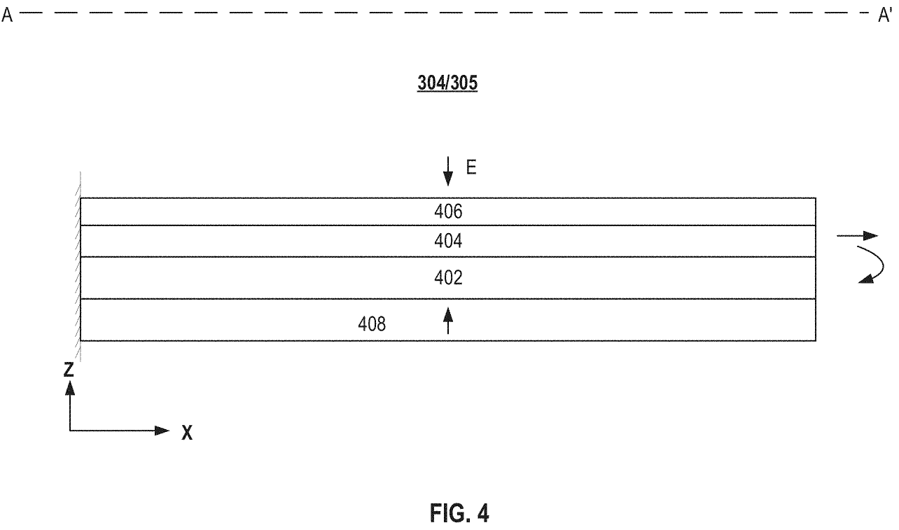

Actuator 304/305 may be an electrical actuator, a magnetic actuator, a piezoelectric actuator, or any device suitable for driving micro mirror 302. In the example illustrated in FIGS. 3A and 3B, actuator 304/305 are piezoelectric actuators. For example, FIG. 4 illustrates a cross-section view of an exemplary piezoelectric actuator 304/305, according to embodiments of the disclosure. For example, piezoelectric actuator 304/305 may include a bottom electrode 402 and a top electrode 406, being fixed and electrically connected to a piezoelectric material 404, configured to provide the electric signal to piezoelectric material 404. In some embodiments, the electrodes and piezoelectric material (e.g., including bottom electrode 402, piezoelectric material 404 and top electrode 406) are disposed on a substrate 408 (e.g., a Si substrate). For example, the electrical signal (i.e., a voltage) applied to piezoelectric material 404 through bottom electrode 402 and top electrode 406 may cause an electrical field between the two sides of piezoelectric material 404.

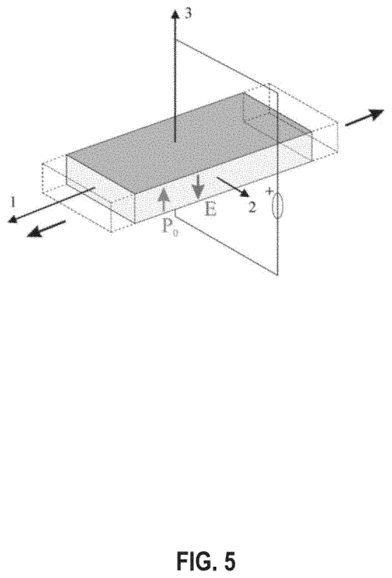

When working in the transversal mode (i.e., the bending mode for piezoelectric actuator 304/305), piezoelectric material 404 may expand in a direction perpendicular to the direction of the polarization and the direction of the electrical field caused by the electrical signal. For example, as shown in FIG. 5, where E is the electrical field caused by the first electrical signal being applied to piezoelectric material 404, and Po is the polarization direction of piezoelectric material 404. When the electrical field E is in a first direction (e.g., in axis 3), parallel to the polarization of piezoelectric material 404, piezoelectric material 404 may expand in a second direction (e.g., in axis 1), perpendicular to the first direction.

Back to FIG. 4, when applying the first electric signal to piezoelectric material 404 through bottom electrode 402 and top electrode 406 in Z axis, piezoelectric material 404 may expand in X axis. In some embodiments, substrate 408 is designed to be non-expandable. The expansion of piezoelectric material 404 may cause the electrodes and piezoelectric material combination to bend towards the non-expandable substrate 408. As a result, when fixing one end of piezoelectric actuator 304/305, the movable end of piezoelectric actuator 304/305 may bend in Z axis. The displacement of the movable end of piezoelectric actuator 304/305 in the Z axis may drive the tilting of micro mirror 302 through connection arrays 310 and 320.

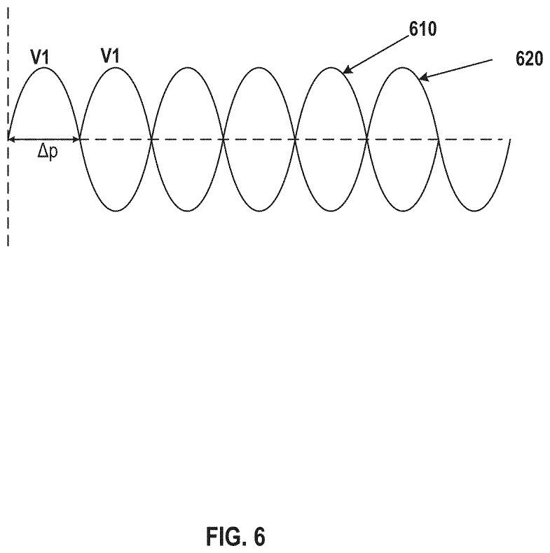

In some embodiments, to achieve an enhanced tilting effect, electric signals having the same frequency but opposite phases (e.g., having a 180-degree phase difference) may be applied to actuators 304 and 305 respectively. For example, FIG. 6 shows an example where signals 610 and 620 have a 180-degree (Δp=π) phase offset but the same amplitude V1. Accordingly, when actuator 304 moves upwards (i.e., bending upwards), actuator 305 may move downwards (i.e., bending downwards). This may enhance the tilting of micro minor 302.

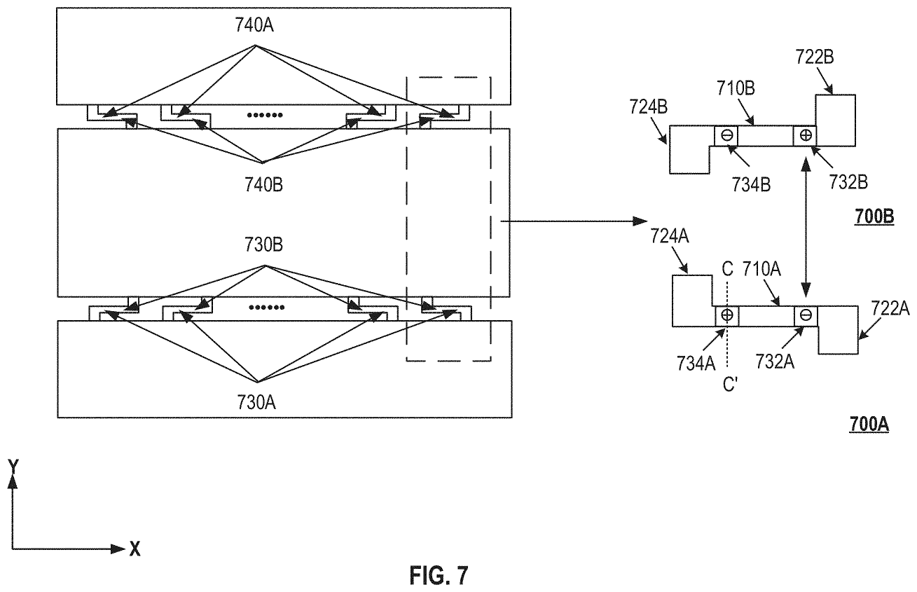

Referring back to FIG. 3A, in some embodiments, the bending displacement of movable end of actuator 304/305 may translate to the rotation of micro mirror 302 (e.g., tilting around axis 309) through first connection array 310 and second connection array 320 respectively. In some embodiments, each of first connection array 310 and second connection array 320 may include a plurality of connections. For example, FIG. 7 illustrates exemplary connections 700A and 700B, according to embodiments of the disclosure. As illustrated in FIG. 7, connections 700A in first connection array 310 are separated by a gap between every two adjacent connections. In some embodiments, each connection 700A may be designed in an S shape. For example, it may include a body part 710A and two intrusions 722A and 724A, connected to two ends of body part 710A. Intrusions 722A and 724A point are in opposite directions to form the S shape. Similarly, each connection 700B in second connection array 320 may include a body part 710B, and intrusions 722B and 724B.

Referring back to FIG. 3A, first connection array 310 may be configured to connect the movable end of actuator 304 to one side of micro mirror 302 through each connection (e.g., connection 700A). For example, intrusions 722A and 724A of each connection 700A in first connection array 310 may be connected to actuator 304 and micro mirror 302 respectively. Second connection array 320 may be configured to connect the movable end of actuator 305 to the opposite side of micro mirror 302 in a similar manner.

In some embodiments, the driving force for tilting micro mirror 302 may cause an in-plane stress within each connection of first connection array 310 and second connection array 320. For example, as illustrated in FIG. 7, the tilting force causes in-plane stresses in connection 700A and 700B in X direction (e.g., along the X axis). Empirically, the largest in-plane stress (e.g., largest in absolute value) may exist roughly at the portions of the body part of each connection close to the intrusions. For example, as illustrated in FIG. 7, in connection 700A, the largest in-plane stress exists at the portions of body part 710A that are close to intrusions 722A and 724A. Similarly, in connection 700B, the largest in-plane stress exists at the portions of body part 710B that are close to intrusions 722B and 724B.

In some embodiments, the left portion and the right portion of each body part are subject to in-plane stresses in opposite directions. For one example, as illustrated in FIG. 7, for connection 700A, the left the portion of body part 710A (e.g., close to intrusion 724 A) may have contracting in-plane stress and the right portion of body part 710A (e.g., close to 722 A) may have expanding in-plane stress.

Accordingly, to detect the in-plane stress of each connection, arrays of piezoelectric sensors 730 (e.g., piezoelectric sensor array 730A or 730B as illustrated in FIG. 7) and 740 (e.g., piezoelectric sensor array 740A or 740B as illustrated in FIG. 7) may be placed at the positions where the largest in-plane stress exists. For example, as illustrated in FIG. 7, piezoelectric sensor array 730 may include a plurality of piezoelectric sensors such as piezoelectric sensors 732A (e.g., piezoelectric sensor array 730A) or 734A (e.g., piezoelectric sensor array 730B) for each connection in first connection array 310 (e.g., connection 700A). For example, piezoelectric sensors 732A and 734A may be disposed at the left and right portions of body part 710A, respectively. Similarly, piezoelectric sensor array 740 may include a plurality of piezoelectric sensors such as piezoelectric sensors 732B (e.g., piezoelectric sensor array 740A) or 734B (e.g., piezoelectric sensor array 740B) for each connection in second array 320 (e.g., connection 700B). Piezoelectric sensors 732B and 734B may be disposed at the left and right portions of body part 710B, respectively.

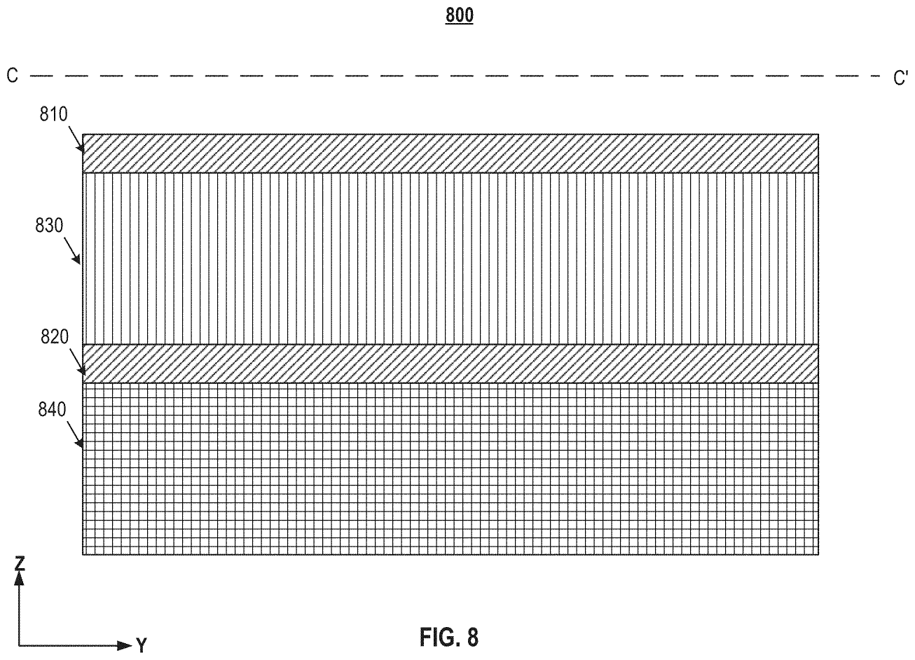

In some embodiments, each piezoelectric sensor may be configured to detect the in-plane stress within each connection based on detecting an in-plane stress applied to a piezoelectric material coupled to the connection. For example, FIG. 8 illustrates a cross-section view along line C-C′ of piezoelectric sensor 734 shown in FIG. 7, according to embodiments of the disclosure. As illustrated in FIG. 8, piezoelectric sensor 800 may include a first electrode 810 and a second electrode 820, sandwiching a piezo material 830. In some embodiments, first electrode 810, second electrode 820 and piezo material 830 may be disposed on a substrate 840 (e.g., a substrate made up of Si). In some embodiments, piezo material 830 may be an integrated part of the connection being sensed.

In some embodiments, piezo material 830 may work in a transversal mode (d₃₁) as disclosed above along with the description of FIG. 5, such that the expansion in the first direction (e.g., perpendicular to the YZ plane in FIG. 8) caused by the in-plane stress may generate an electric field E in a second direction (e.g., along Z axis in FIG. 8). The electric field E corresponding to the in-plane stress may be sensed by first electrode 810 and second electrode 820 that sandwich piezo material 830. Accordingly, by sensing the electric field E corresponding to the in-plane stress, the in-plane stress in piezo material 830 may be detected.

As shown in FIG. 8, the overlapping portion of first electrode 810 and second electrode 820 in X direction may form a capacitor. The electric field E applied to the capacitor is therefore proportional to the electric charge Q on the electrodes. The electric charge is in turn a product of the voltage V between first electrode 810 and second electrode 820 and the capacitance. Therefore, by measuring the voltage V, the corresponding electric field E may be measured. For example, the voltage V may be calculated according to equation (1):

$$V = \frac{Q}{C} \qquad ( 1 )$$

where Q is the charge of piezoelectric sensor 800, C is the overall capacitance of the senor array. In some embodiments, as the charge Q is proportional to the in-plane stress which is proportional to the rotation angle of micro mirror 302, the detected electric signal voltage V may be proportional to the rotation angle of micro mirror 302 accordingly. By sensing the voltage V, the rotation angle of micro mirror 302 may be detected as a result.

In some embodiments, a controller (e.g., controller 220) may be coupled to piezoelectric sensor 800 for determining the rotation angle of micro mirror 302 based on the sensed electrical signal and the overall capacitance. For example, the relationship between the sensed electrical signal and the rotation angle of micro mirror 302 may be determined according to an empirical formula or a lookup table, predetermined based on experiments or simulations. Accordingly, based on the sensed electric signal, rotation angle of micro mirror 302 may be accurately detected by the controller, and thus be used to precisely control the tilting of micro minor 302 for scanning the FOV.

For example, for detecting the in-plane stress at connection 700A, as illustrated in FIG. 7, piezoelectric sensors 732A or 734A may be disposed at the left portion or right portion of body part 710A as disclosed above. Accordingly, the in-plane stress in body part 710A of connection 700A may be sensed based on reading out the electric signal detected by first and second electrodes 810 and 820. In some embodiments, first and second electrodes 810 and 820 may be connected to a readout circuit for reading the sensed electric signal.

In some embodiments, the electric signal generated by each piezoelectric sensor of each piezoelectric sensor array (e.g., piezoelectric sensor array 730 and/or 740) may be concatenated such that the detecting scheme disclosed herein can be more robust. For example, the piezoelectric sensors in piezoelectric sensor array 730 and/or 740 may be connected in series such that the electric signal generated by each piezoelectric sensor may be added up to generate an overall output. The overall output may be the sum of all the individual sensed electric signals of the piezoelectric sensors in the piezoelectric sensor array. Accordingly, the sensitivity requirement for the readout circuit to read the output may be reduced.

For another example, each piezoelectric sensor in piezoelectric sensor array 730 and/or 740 may also be connected in parallel, such that the inverse of the electric signal generated by each piezoelectric sensor are concatenated. The overall capacitance of in piezoelectric sensor array 730 and/or 740 become a sum of the capacitances of all the individual sensors in the array. In this way, the robustness (i.e., the capability to resist the noise) of the detecting scheme can be increased because of the increased capacitance as a result of the parallel connection. It is contemplated that a different topology may be used to concatenate the electric signals of the individual sensors in an array. For example, a combination of series connections and parallel connections may be implemented.

In some embodiments, because of the phase offset of the electric signal applied to actuators 304 and 305, actuators 304 and 305 at each time point may move in an opposite direction for enhancing the tilting of micro mirror 302 as disclosed above. Accordingly, corresponding piezoelectric sensors in piezoelectric sensor array 730 and 740, (e.g., piezoelectric sensor 732A and 732B, or piezoelectric sensor 734A and 734B shown in FIG. 7) may sense opposite electric signals because of the opposite movement directions of actuators 304 and 305. Accordingly, to further increase the robustness of the detecting scheme, the detected electric signals of the corresponding piezoelectric sensors may be used as inputs for generating a differential signal. In this way, the system error, e.g., the noise brought in by the components of the detecting scheme, may be further reduced.

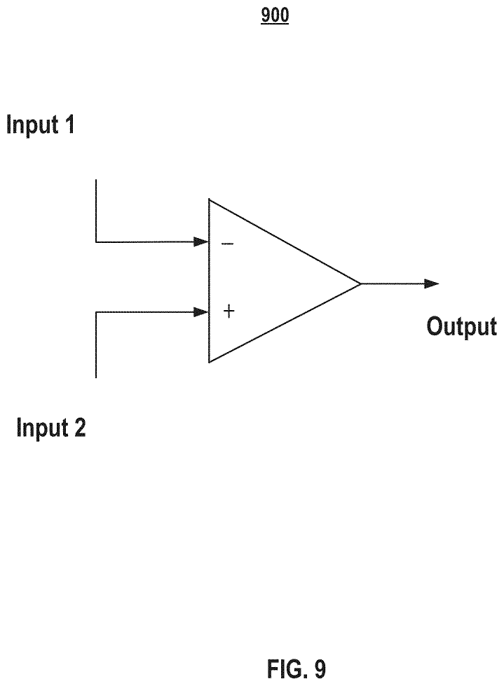

For example, FIG. 9 illustrates an exemplary differentiator 900, according to embodiments of the disclosure. As illustrated in FIG. 9, the sensed electric signals of the corresponding piezoelectric sensors may be input to differentiator 900, where a differential signal is generated between the sensed electric signals of the corresponding piezoelectric sensors as an output of differentiator 900. Using the output of differentiator 900 may further eliminate the system error, because the system errors in each sensed electric signal of the corresponding piezoelectric sensors would cancel out each other when being combined for generating the differentiation signal.

In some embodiments, the detected electric signals of the corresponding piezoelectric sensors may also be used to detect a direction of the titling. For example, the direction of the titling may be determined based on the polarity of the sensed electric signals by the corresponding piezoelectric sensors.

In some embodiments, the overall capacitance includes a capacitance of the piezoelectric sensor and a parasitic capacitance. To further improve the robustness of the detecting scheme, in some embodiments, the parasitic capacitance may be reduced through modifications of the piezoelectric sensor design. For example, according to equation (2), the larger the parasitic capacitance is, the smaller the value of the output electric signal the piezoelectric sensor may have.

$$V = \frac{Q}{{C}_{s} + {C}_{p}} \qquad ( 2 )$$

where Cₛ is the capacitance of piezoelectric sensor, and Cₚ is the parasitic capacitance. Accordingly, by reducing the parasitic capacitance, the detected electric signal generated by each piezoelectric sensor may increase.

The parasitic capacitance between two electrodes can be determined according to Equation (3):

$${C}_{p} = \frac{A {ɛ}_{r} {ɛ}_{0}}{d} \qquad ( 3 )$$

where A is the overlap area between top and bottom electrodes, εᵣ is the relative permittivity, ε₀ is the vacuum permittivity, and d is distance between top and bottom electrodes. Therefore, the parasitic capacitance can be reduced by reducing the overlapping area A between the electrodes of the piezoelectric sensor.

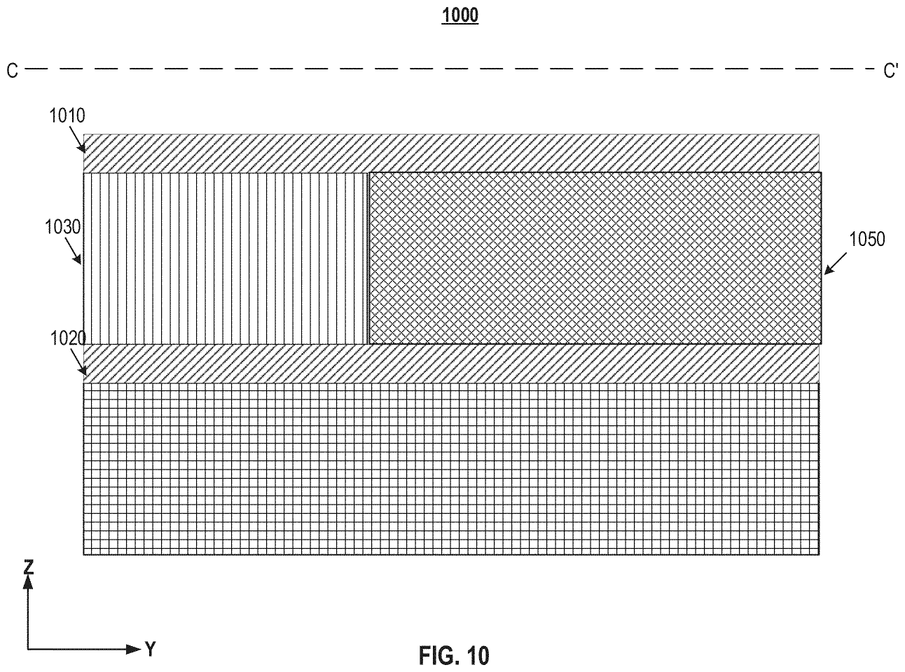

For example, FIG. 10 illustrates a cross-section view of an exemplary piezoelectric sensor 1000 with reduced parasitic capacitance, according to embodiments of the disclosure. As illustrated in FIG. 10, piezoelectric material 1030 may only partially extend over a space between first electrode 1010 and second electrode 1020. In some embodiments, the remaining space may be left unfilled, thus the overlapping area is only part of the size of first electrode 1010 and second electrode 1020. In some other embodiments, the remaining space may be filled with material 1050 with a low dielectric constant (Low-κ dielectric). Accordingly, because material 1050 may be considered close to dielectric, the effective overlapping area may be reduced, and the parasitic capacitance formed in piezoelectric sensor 1000 may also be reduced.

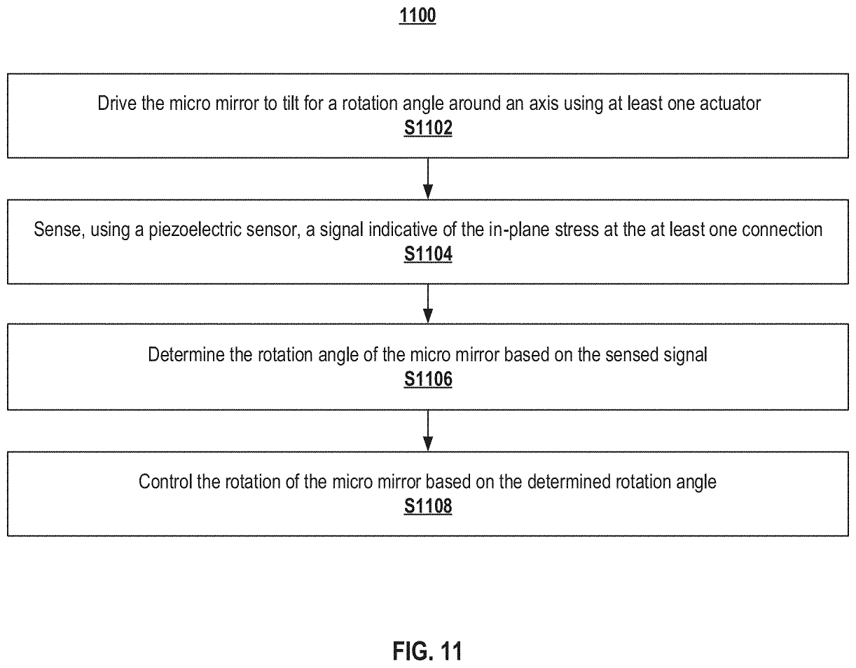

FIG. 11 illustrates a flow chart of an exemplary method 1100 for sensing rotation angles of a micro mirror within a micromachined mirror assembly, according to embodiments of the disclosure. It is to be appreciated that some of the steps may be optional. Further, some of the steps may be performed simultaneously, or in a different order than shown in FIG. 11.

In step S1102, a micro mirror (e.g., micro mirror 302) within a micromachined mirror assembly (e.g., micromachined mirror assembly 300) may be driven to tilt for a rotation angle around an axis (e.g., axis 309). For example, as illustrated in FIG. 3A, the micromachined mirror assembly may include actuators 304 and 305 mechanically connected to micro mirror 302, through at least one connection (e.g., first and second connection arrays 310 and 320). In some embodiments, the tilting of the micro mirror causes an in-plane stress on the connections.

In step S1104, a signal indicative of the in-plane stress at the at least one connection may be sensed using at least one piezoelectric sensor. For example, as illustrated in FIG. 8, the piezoelectric sensor may include a first and a second electrodes (e.g., first and second electrodes 810 and 820), sandwiching a piezoelectric material (e.g., piezoelectric material 830). The piezoelectric sensor may be coupled to a portion of a body part of the connection, e.g., where the in-plane stress with the largest value exists. The in-plane stress within the body of the connection may be sensed by the piezoelectric material of the piezoelectric sensor. An electrical signal (e.g., the voltage V) proportional to the in-plane stress may be sensed by the piezoelectric sensor through the electrodes of the piezoelectric sensor.

In step S1106, the rotation angle of the micro mirror may be determined by controller 220 coupled to piezoelectric sensor, based on the sensed electrical signal. For example, the sensed electrical signal may be proportional to the in-plane stress at the connection, which is in turn proportional to the rotation angle of the micro mirror. The rotation angle of the micro mirror may be determined using the sensed electrical signal by an empirical formula and/or a lookup table predetermined based on experiments or simulations.

In some embodiments, in step S1108, the determined rotation angle of the micro mirror may be used for controlling the rotation of the micro mirror. For example, a close loop control of the rotation angle of the micro mirror may be applied based on the detected rotation angle of the micro mirror. For example, controller 220 may compare the sensed rotation angle with the angle micro mirror 302 was actuated to rotate to (the intended angle) in step S1102. If the sensed angle is smaller than the intended angle, controller 220 may send a control signal to actuate micro mirror 302 to increase the rotation angle. Otherwise, if the sensed angle is larger than the intended angle, controller 220 may send a control signal to pull micro mirror 302 a bit to decrease the rotation angle. Using the close loop control based on a real-time sensing of the actual rotation angle, micro mirror 302 may be adjusted to an angle that is truly intended. LiDAR scanning and receiving accuracy can be improved accordingly.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A micromachined mirror assembly for reflecting optical signals in an optical sensing system, the micromachined mirror assembly comprising:
a micro mirror;
at least one actuator mechanically connected to the micro mirror through at least one connection, configured to drive the micro mirror to tilt for a rotation angle around an axis, causing an in-plane stress on the at least one connection; and
at least one piezoelectric sensor configured to detect the rotation angle of the micro mirror based on a signal indicative of the in-plane stress sensed at the at least one connection.

2. The micromachined mirror assembly of claim 1, wherein the at least one piezoelectric sensor is configured to detect the in-plane stress applied to a piezoelectric material, wherein the in-plane stress applied to the piezoelectric material in a first direction causes an electrical field in the piezoelectric material in a second direction, perpendicular to the first direction.

3. The micromachined mirror assembly of claim 2, wherein the at least one piezoelectric sensor further comprises a first electrode and a second electrode sandwiching the piezoelectric material, wherein the first and second electrodes are configured to sense an electrical signal associated with the electrical field formed in the piezoelectric material.

4. The micromachined mirror assembly of claim 3, wherein the piezoelectric material only partially extends over a space between the first electrode and the second electrode in order to reduce a parasitic capacitance formed between the first and second electrodes.

5. The micromachined mirror assembly of claim 1, wherein the at least one connection comprises a plurality of connections on one side of the micro mirror, wherein the piezoelectric sensor comprises a plurality of sensors each configured to sense the signal at a respective connection.

6. The micromachined mirror assembly of claim 5, wherein the plurality of sensors are connected in series such that the signals sensed at the plurality of connections are concatenated.

7. The micromachined mirror assembly of claim 5, wherein the plurality of sensors are connected in parallel such that the inverse of the signals sensed at the plurality of connections are concatenated.

8. The micromachined mirror assembly of claim 1, wherein the at least one connection comprises at least two connections, wherein a first connection connects one side of the micro mirror to a first actuator and a second connection connects an opposite side of the micro mirror to a second actuator,
wherein the piezoelectric sensor comprises a first sensor configured to sense a first signal from the first connection and a second sensor configured to sense a second signal from the second connection.

9. The micromachined mirror assembly of claim 8, wherein the piezoelectric sensor is further configured to detect a direction in which the micro mirror is tilted based on the first and second signals.

10. The micromachined mirror assembly of claim 8, wherein the piezoelectric sensor further comprises a differentiator configured to generate a differential signal between the first signal sensed by the first sensor and the second signal sensed by the second sensor.

11. The micromachined mirror assembly of claim 1, wherein the at least one connection comprising a body part and two intrusions connected to two ends of the body part, wherein the two intrusions point in opposite directions, forming an S shape.

12. The micromachined mirror assembly of claim 1, wherein the piezoelectric sensor is further coupled to a controller configured to determine the rotation angle of the micro mirror proportionally to the signal sensed by the at least one piezoelectric sensor.

13. The micromachined mirror assembly of claim 12, wherein the controller is further configured to determine an overall capacitance including a capacitance of the piezoelectric sensor and a parasitic capacitance, and determine the rotation angle of the micro mirror inverse proportionally to the overall capacitance.

14. A method for sensing rotation angles of a micro mirror, comprising:
driving the micro mirror to tilt for a rotation angle around an axis using at least one actuator mechanically connected to the micro mirror through at least one connection, wherein the tilting of the micro mirror causes an in-plane stress on the at least one connection;
sensing, using a piezoelectric sensor, a signal indicative of the in-plane stress at the at least one connection; and
determining the rotation angle of the micro mirror based on the sensed signal.

15. The method of claim 14, wherein the piezoelectric sensor is configured to detect the in-plane stress applied to a piezoelectric material, wherein the in-plane stress applied to the piezoelectric material in a first direction causes an electrical field in the piezoelectric material in a second direction, perpendicular to the first direction.

16. The method of claim 15, wherein the piezoelectric sensor further comprises a first electrode and a second electrode sandwiching the piezoelectric material, wherein the first and second electrodes are configured to sense an electrical signal associated with the electrical field formed in the piezoelectric material.

17. An optical sensing system, comprising:
a transmitter configured to emit optical signals in a plurality of directions;
a receiver configured to detect reflected optical signals; and
a micromachined mirror assembly comprising:
a micro mirror;
at least one actuator mechanically connected to the micro mirror through at least one connection, configured to drive the micro mirror to tilt for a rotation angle around an axis, causing an in-plane stress on the at least one connection; and
at least one piezoelectric sensor configured to detect the rotation angle of the micro mirror based on a signal indicative of the in-plane stress sensed at the at least one connection.

18. The optical sensing system of claim 17, wherein the piezoelectric sensor is configured to detect the in-plane stress applied to a piezoelectric material, wherein the in-plane stress applied to the piezoelectric material in a first direction causes an electrical field in the piezoelectric material in a second direction, perpendicular to the first direction.

19. The optical sensing system claim 18, wherein the piezoelectric sensor further comprises a first electrode and a second electrode sandwiching the piezoelectric material, wherein the first and second electrodes are configured to sense an electrical signal associated with the electrical field formed in the piezoelectric material.

20. The optical sensing system of claim 19, wherein the piezoelectric material only partially extends over a space between the first electrode and the second electrode in order to reduce a parasitic capacitance formed between the first and second electrodes.
